(19) United States
(12) Patent Application Publication
(10) Pub. No.: US 2026/0037948 A1
(43) Pub. Date: Feb. 5, 2026

(54) MAPPING A NEW MACHINE LEARNING MODEL OUTPUT FOR USE WITH AN EXISTING SYSTEM

(71) Applicant: NCR VOYIX CORPORATION, ATLANTA, GA (US)

(72) Inventor: Joseph H. Deerin, Atlanta, GA (US)

(21) Appl. No.: 18/789,020

(22) Filed: Jul. 30, 2024

(51) Int. Cl. G06Q 20/20; G06V 10/764

(52) U.S. Cl. CPC G06Q 20/208; G06V 10/764

(57) ABSTRACT

A computer-implemented method generates a conversion matrix for mapping an output of a second machine learning model to an expected output of a first machine learning model. A set of example data is iteratively fed to the first machine learning model to create a set of first outputs and to the second machine learning model to create a set of second outputs. For each output of the set of first outputs and a corresponding output of the set of second outputs, a matrix is generated based on an optimization technique that maps the output of the second machine learning model to the output of the first machine learning model. Each of the generated matrices is summed to create an initial conversion matrix. Finally, each column of the initial conversion matrix is normalized to generate the conversion matrix.

### FIELD

This disclosure relates generally to a method for mapping a new machine learning model output for use with an existing system, and more particularly to a method which uses optimization methods to develop a mapping from the output of a new machine learning model to the output of an existing machine learning model in order to substitute the new model for the old model.

### BACKGROUND

The use of machine learning models has increased in recent years in part due to the need for more accurate and efficient image classification, such as with respect to image-based item recognition systems. However, training these models with a large set of training images of the candidate items can be challenging due to the high dimensionality of the data, which can lead to lower performance or poorer accuracy in the models when new data is presented. One way of addressing this issue is to provide a layered approach where a root-level machine learning model (the “root model”) receives an item image captured of an item at a terminal, and produces a coarse grain feature vector associated with an item classification for the item as output. This vector will have a particular matrix size, e.g., 1×N. Transaction information for a transaction at the terminal is obtained and based on the transaction information a head machine learning model (the “head model”) is selected from a plurality of head models. A candidate item identifier is received from the terminal. The head model then uses the candidate item identifier, the output from the root model, and localized metadata maintained for the head model to provide a predicted item identifier for the item.

In some cases, a new version of the root model may be required to properly implement the layered system. This may be necessary when, for example, installing an image-based item recognition system in a new location or when an improved (more efficient) version of the root model has been created. However, if the new version of the root model has a different-sized output vector (e.g., 1×M), then adapting the new version to work with an existing system may be problematic. Existing approaches for addressing this issue are extremely time-consuming and inefficient.

The present disclosure describes a technical solution that solves the above-noted technical problem. When the mapping method of the present disclosure is applied to update a layered system, the resultant system will have improved performed generated in a much more efficient manner than previously known.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of an image-based item recognition system according to an aspect of the current disclosure;

FIG. 2 is a block diagram of a mapping function of the current disclosure;

FIG. 3 is a flowchart showing the generation of the mapping function of the current disclosure;

FIG. 4 is a flowchart showing additional details of one aspect of the mapping function of FIG. 2; and

FIG. 5 is a schematic block diagram of an example computing system for use with aspects of the current disclosure.

### DETAILED DESCRIPTION

In the present disclosure, like reference numbers refer to like elements throughout the drawings, which illustrate various exemplary embodiments of the present disclosure.

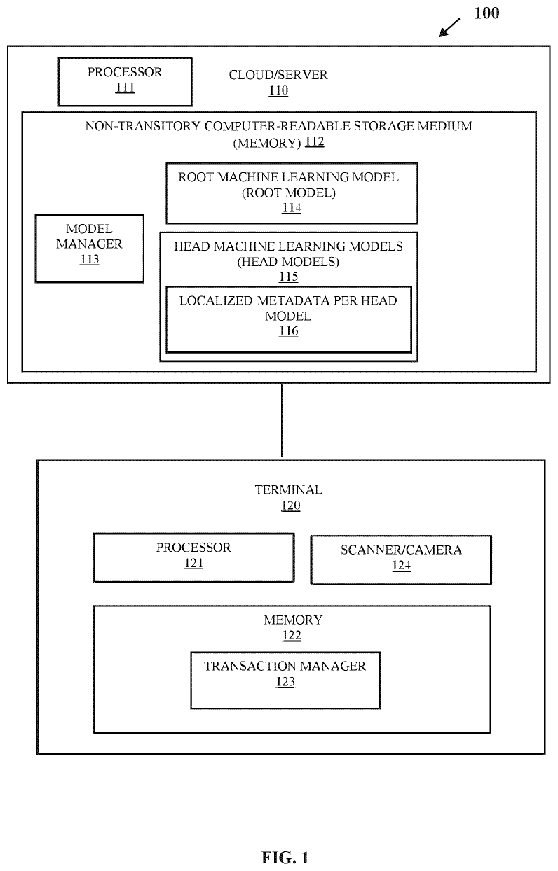

FIG. 1 is a diagram of an image-based item recognition system 100. It is to be noted that the components are shown schematically in greatly simplified form, with only those components relevant to understanding of the embodiments being illustrated.

The system includes a server 110 and one or more terminals 120. Server 110 may be remote from the terminals(s) 120. Server 110 includes a processor 111 and a non-transitory computer-readable storage medium 112 (e.g., a non-volatile memory) which holds executable instructions for a model manager 113, a root model 114, and a plurality of head models 115. Each head model 115 further includes localized metadata 116.

Each terminal 120 includes a processor 121 and a non-transitory computer-readable storage medium 122 (e.g., a non-volatile memory) which includes executable instructions for a transaction manager 123. Each terminal 120 further includes at least one scanner/camera 124 (which preferably includes an integral or associated weigh scale) to capture at least one image of an item during a transaction at the corresponding terminal 120.

Root model 114 is trained on a plurality of item images for items. This includes a plurality of images for each item. The root model 114 is trained to produce, as output, an item classification feature vector, a seed item classification vector, or another root model output that includes a plurality of identified features along with corresponding probabilities representing a respective significance, importance, or contribution of each feature to the predicted item classification determination. The features may represent dimensions associated with visual attributes identified in a given item image, such as and by way of example only, colors, shape, lines, edges, dimensions, packaging, etc. The data sets of item images used for training root model 114 may span, for example, multiple different retail stores and/or multiple different retailers across a large geographical area. As a result, any item classification feature vector or root model output provided from the root model 114 includes a large number of feature dimensions and is coarse grain. The output of root model 114 is in the form of a vector V1 having a fixed size, e.g., 1×N or N×1. Although a 1×N or N×1 matrix is provided as an example vector size, it is important to note that matrices of different sizes can be used depending on the specific requirements and context of the particular application. The system and method of the present disclosure can be adapted for use with machine learning models having output vectors having various dimensions, such as 1×N, N×1, N×M, or M×N, where ‘N’ and ‘M’ represent different integers.

Model manager 113 provides the feature vectors produced by the root model 114 as an input to a selected head model 115 as a seed or as a seed item classification feature vector. Model manager 113 selects a given head model 115 based on any number of factors, such as a store identifier associated with a store, a terminal identifier associated with a given terminal 120, a department within a store where a given terminal 120 is known to reside, a geographic region of the store, a customer identifier for a customer, etc.

In an embodiment, model manager 113 maintains one or more hierarchies to which the head models 115 are linked. Model manager 113 uses known transaction information provided by the terminal 120 during a transaction to traverse the hierarchy and select a given head model 115. For example, the hierarchies may be maintained per geographical region, per retailer, per store, etc., and the transaction information may identify a retailer, a store, a department, the terminal 120, and/or a customer associated with the transaction. In this example, model manager 113 maps a store identifier to a geographical location and traverses a given hierarchy with remaining portions of the transaction information to locate and identify a specific head model 115 for the transaction based on the retailer, the store, the department, the terminal 120, and/or the customer.

Each head model 115 is trained on labeled input data that includes a seed item classification vector or root model output and an operator-provided candidate item identifier for a given labeled known item. Following training, the corresponding head model 115 has created unique localized metadata, which the head model 115 relies on to provide predicted item identifiers. In an embodiment, the localized metadata 116 is a heuristic table that includes, by way of example only, the seed item classification vectors received from the root, averages of seed item classification vectors, moving averages of the seed item classification vectors, probabilistic moving averages of the seed item classification vectors, ranges of seed item classification vectors, specific feature-based probabilities/weights, item purchase statistics, terminal purchase statistics, calendar dates, days of week, times of day, known holiday dates, department purchase statistics, customer-specific purchase statistics, and item identifiers for items of a store associated with a given terminal. Each head model 115 processes its localized metadata 116 using a provided seed item classification vector or root model output and an operator-provided candidate item identifier to resolve a predicted item identifier during any given transaction at a given terminal 120.

Following training of a given head model 115, the head model receives a seed item classification vector or root model output and an operator-provided candidate item identifier, and relies on or processes its existing localized metadata to produce a predicted item identifier. In making any given prediction, the head model 115 can update the localized metadata 116.

During a given transaction at a given terminal 120, an item image is captured of an item placed on the weigh scale associated with scanner/camera 124. Camera 124 captures the item image and makes the item image accessible through a monitored network location or provides the item image to model manager 113. Transaction manager 123 simultaneously provides transaction information for the transaction to model manager 113. Model manager 113 provides the item image to root model 114 and receives a corresponding seed item classification vector or root model output. Model manager 113 selects an appropriate head model 115 based on the transaction information for the transaction.

The transaction information provided by manager 123 also includes a candidate item identifier for the item. The candidate item identifier may be provided by either transaction manager 123 when a scanner 124 scanned an item barcode off the item or by an operator who manually entered the candidate item identifier. When the operator provides the candidate item identifier, the item is likely, but not always, associated with a produce item for which the transaction manager 123 needs a PLU code for the transaction.

Model manager 113 provides the seed item classification vector or root model output and the candidate item identifier to the selected head model 115 and receives as output a predicted item identifier for the item based on the head model's localized metadata 116. Model manager 113 provides the predicted item identifier back to transaction manager 123. Manager 123 records the predicted item identifier with the transaction when the candidate item identifier matches the predicted item identifier.

In an embodiment, when the candidate item identifier does not match the predicted item identifier, manager 123 displays a model image of the item associated with the predicted item identifier to the operator of terminal 120 through the transaction interface and requests that the operator confirm that the displayed item is what the operator intended to enter instead of the candidate item identifier. When the operator insists through a selection that the item is associated with the candidate item identifier, manager 123 requests an intervention and suspends the transaction from completing until an attendant is dispatched to the terminal 120 for item verification.

Continuing with the latter embodiment, the attendant can either select the item from an override transaction interface as being associated with the candidate item identifier, the predicted item identifier, or a completely different item identifier. When the attendant overrides the predicted item identifier to be the candidate item identifier or the different item identifier, transaction manager 123 reports the change back to model manager 113. Model manager 113 uses the changed item identifier to update the selected head model's localized metadata 116. This causes the head model 115 to update its item predictions, which are based on its localized metadata 116.

In an embodiment, even when the actual item identifier is the predicted item identifier, model manager 113 updates the corresponding localized metadata 116 to include the seed item classification vector or root model output, the actual item identifier, a retailer identifier for the retailer, a terminal identifier for the terminal, and/or a store identifier for the store.

As a result, each head model 115 is continuously tuned in real-time as its localized metadata 116 is updated by model manager 113. This can improve the accuracy of each of the head models 115 without manual retraining and without manual maintenance.

In an embodiment, terminal 120 is a self-service terminal (SST) or a point-of-sale (POS) terminal. In an embodiment, the operator of the terminal 120 is a customer when the terminal 120 is an SST. In an embodiment, the operator of the terminal 120 is a cashier when the terminal 120 is a POS terminal. In an embodiment, each head model 115 is embedded in a corresponding terminal 120 and processes on that terminal 120. In an embodiment, the root model 114 and a corresponding head model 115 are embedded in terminals 120 and are processed on that terminal 120. In an embodiment, the root model 114 is deployed as different instances of a same model on the terminals 120, whereas each terminal includes a different head model 115. In an embodiment, the processing associated with the model manager 113 is subsumed within and processed on the terminals 120.

As explained herein, there are circumstances in which it may be desirable to update a system that uses a first (original) machine learning model to instead use a second (new) machine learning model. In some cases, the original machine learning model (like root model 114) may have a vector V1 output of size 1×N and the new machine learning model may have a different vector V2 output size, e.g., 1×M, or have different meanings for the categories within the different vector V2, e.g., V2(1) may represent a completely different product than V1(1), and, without additional change, would be incompatible with the system. Considerable effort is typically required to update the system to use the new machine learning model. A custom mapping from the original machine learning model to the new machine learning model can be generated, but this is a manual, time-consuming, and error-prone process. Moreover, it is often not clear how categories in the original model relate to the new model, further exacerbating the custom mapping approach. Another conventional approach is to pass all original data to the new machine learning model. This approach is both time and storage intensive and does not work if any of the original input data is not available (e.g., has been deleted or lost). Moreover, even if all of the original data is available, this approach does not create a mapping at all, but rather merely updates the encoded data to work with the new model.

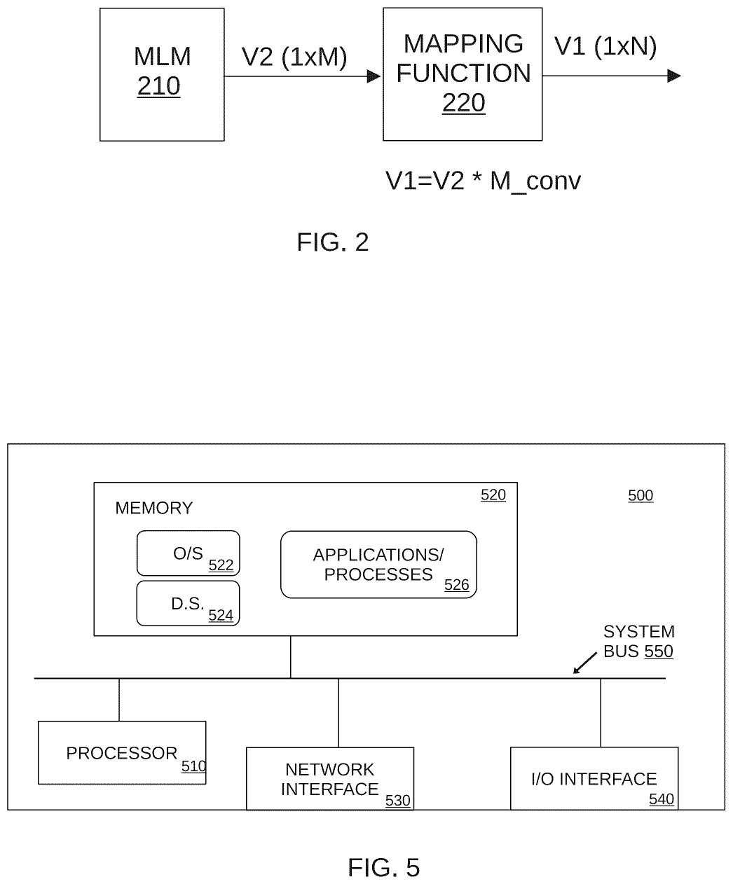

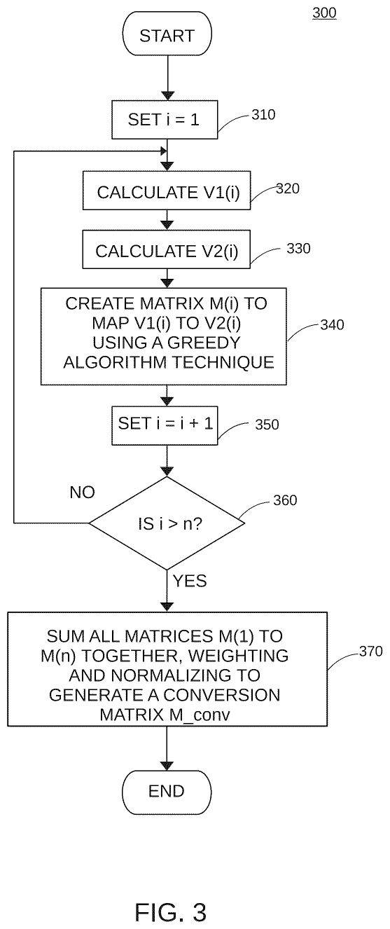

The present disclosure provides a technical solution that solves the above-described technical problems with existing approaches by providing a mapping function module that performs a translation of the vector V2 of the new machine learning model to the vector V1 of the original machine learning model or a translation of vector V1 to vector V2 (via a size translation or a product category translation). This is shown in FIG. 2, where a machine learning model (MLM) 210 has an output vector size V2 of (1×M). MLM 210 corresponds to, for example, a new machine learning model for use in the system 100 of FIG. 1 but which has an output that is not compatible, without additional changes, with system 100. The output of MLM 210 is provided to a mapping function 220 which, as explained in detail below, operates on the V2 (1×M) array to generate an output vector V1 (1×N) that is compatible with system 100. The mapping function 220 performs a matrix multiplication of the input with a two-dimensional matrix M_conv that is generated by a greedy algorithm described with respect to the flowchart of FIG. 3 below. The output V1 of the mapping function 220 is thus calculated as: V1=V2*M_conv. By incorporating the mapping function 220, any system which implements an original machine learning model with a first output array size can be modified to use a new machine learning model having a second different output size without the need for extensive modifications. For example, if a new root model 114 was generated for system 100, it would only be necessary to create a mapping function 220, as described below, and add a step in which the output of the new root model 114 is first processed by the mapping function 220 before being provided to the head model 115 in order to update system 100 to incorporate this new root model 114.

In some embodiments, the mapping function 220 serves to convert the source vector V1 (e.g., output of an original MLM) to the target vector V2 (e.g., output of new MLM 210) such that data encoded with the original MLM can be efficiently transferred to a new format of the new MLM 210 without having to discard the data, without having to manually convert the data to the new format, without having to make expensive calls to the new MLM, and without having to tediously create a conversion function that only works for 2 specific machine learning models. In this manner, embodiments of the present disclosure substantially reduce the burden of upgrading software to newer machine learning models.

The outputs of a first (e.g., old) machine learning model can be mapped to the outputs of a second (e.g., new) machine learning model by sequentially feeding a set of example data to each of the first and second models, creating a matrix for each data item that maps the output of the first model to the output of the second model, and then summing all of the matrices together to generate a conversion matrix M_conv. This process is much less time consuming than the process of creating a custom mapping from the old model to the new machine learning model because the set of example data used can be significantly smaller than the entire set of data originally encoded by the old machine learning model. Applying the conversion matrix to an existing system in conjunction with updating an existing machine learning model greatly improves the functionality of the system in extremely efficient manner.

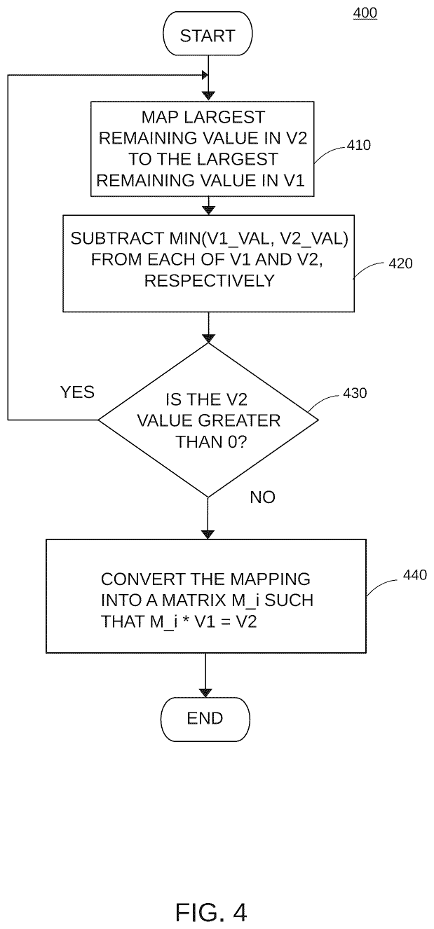

This process is shown in the flowchart 300 of FIG. 3. Assuming a sample set of n items, the process starts by setting the index i to 1 at step 310, and then calculating an output vector V1(i) from the first machine learning model based upon item(i) of the n items (step 320) and an output vector V2(i) from the second machine learning model based upon the item(i) of the n items (step 320). Next, a matrix M(i) is created to map V1(i) to V2(i) at step 350. The matrix M(i) is preferably calculated using a greedy algorithm technique as discussed with respect to FIG. 4. The index i is incremented at step 350 and a check is performed at step 360 to determine if all n data items have been iterated through. If not, processing reverts to step 320 to perform the same series of operations based on the next data item. If all n data items have been used, processing proceeds to step 370, where all the matrices M(1) to M(n) are summed together. Each row of each matrix M(i) is weighted by its respective target vector V2(i) and summed together, i.e., M_tot=V2(1)*M(1)+V2(2)*M(2) . . . +V2(n)*M(n). After this summation, each column of the matrix M_tot is normalized so that all elements in each column sum to 1.0 to produce a final conversion matrix M_conv that can be used as explained above with respect to FIG. 2.

A greedy algorithm is an optimization technique for solving problems by making the locally optimal choice at each stage in order to identify a solution. In example embodiments, the present disclosure makes use of this type of optimization in generating the M_conv matrix. Referring now to the flowchart 400 in FIG. 4, the optimization process first involves mapping, at step 410, the largest remaining value in V2(i) to the largest remaining value in V1(i), which can include determining what percent of the V1 value is needed to equal the V2 value. Then the min (V1_val, V2_val) is subtracted from each of V1_val and V2_val, respectively, at step 420. This involves identifying the largest element in each vector (V1 and V2) and subtracting the smaller of the two identified elements from each of the identified largest elements. As part of this process, the elements of V1 and their corresponding indices are matched with the elements of V2 and their corresponding indices to a generate the mapping. As further part of this process, if an element of a vector was already subtracted, the percent of the original element that remains is noted. For example, if the two vectors constitute: V1=[1, 2, 3, 4] and V2=[5, 1, 1, 2], and the vector indices start at 1, the largest values in each are V1(4)=4 and V2(1)=5. V1(4) is the smaller value of the two, and is subtracted from each, resulting in V1=[1, 2, 3, 0] and V2=[1, 1, 1, 2]. If the V2 value is found to be greater than 0 at step 430, steps 410 and 420 are repeated until the V2 value equals 0. Finally, at step 440, the mapping is converted into a matrix M(i) so that M(i)*V1=V2. Matrix M(i) is then stored in order to generate the conversion matrix M_conv according to the process defined in FIG. 3.

FIG. 5 is a schematic block diagram of an example computing system 500 that may be used with one or more embodiments described herein, e.g., to perform the methods shown in FIGS. 3 and 4. Computer system 500 may include at least one processor 510, a memory 520, one or more network interfaces 530 (e.g., wired, wireless, etc.), and one or more input/output (I/O) interfaces 540, which may be interconnected by a system bus 550. The network interface(s) 530 and the I/O interface(s) 540 are referred to in the singular hereinafter for ease of explanation. The network interface 530 contains the necessary circuitry for communicating data over links coupled to a network. The network interface 530 may be configured to transmit and/or receive data using a variety of different communication protocols. Note, further, that configuration of computer system 500 shown in FIG. 5 is merely illustrative, and computer system 500 may have multiple types of network connections via multiple network interfaces 530, e.g., wireless and wired/physical connections.

The memory 520 may include a plurality of storage locations that are addressable by the processor 510 and the network interface 530 for storing software programs and data structures associated with the embodiments described herein, including but not limited to the methods of FIGS. 4 and 5. The parts of memory 520 that store software programs, including any operating system, may be a non-transitory computer-readable storage medium. The processor 510 may comprise hardware elements or hardware logic adapted to execute software programs and manipulate the data structures 524. An operating system 522, portions of which are typically resident in memory 520 and executed by the processor 510, functionally organizes the computer system 500 by, among other things, invoking operations in support of software processes and/or services executing on the computer system 500. These software processes and/or services may include one or more applications/processes 526.

The I/O interface 540 may not be present in all embodiments, but when present, typically includes a user interface (UI) that has an input device, such as an alpha-numeric keypad (e.g., a keyboard) for inputting alpha-numeric and other information, a pointing device (e.g., a mouse, a trackball, stylus, or cursor direction keys), a touchscreen, a microphone, a camera, and so forth.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A system, comprising:
a transaction terminal comprising at least one processor and a non-transitory computer-readable storage medium;
at least one server comprising at least one processor and a non-transitory computer-readable storage medium, the at least one server coupled to the transaction terminal;
the non-transitory computer-readable storage medium comprising executable instructions; and
the executable instructions when executed by at least one processor cause the at least one processor to perform operations, comprising:
receiving, from the transaction terminal, transaction information for a transaction including an item image for an item of the transaction;
providing the item image to an updated root machine learning model (MLM);
receiving item classification data determined by the updated root MLM from the item image;
providing the item classification data to a mapping function to produce a mapped version of the item classification data;
providing the mapped version of the item classification data to a head MLM;
receiving a predicted item identifier from the head MLM based on localized metadata processed by the head MLM using the item classification data;
providing the predicted item identifier to the transaction terminal; and
receiving an actual item identifier for the item from the transaction terminal.

2. The system of claim 1, wherein the mapping function is a conversion matrix for converting a second output vector V2 representing the item classification data from the updated root MLM to a form of a first output vector V1 representing item classification data from an original root MLM, the conversion matrix generated by:
iteratively feeding a set of example data to the original root MLM to create a set of first outputs and to the updated root MLM to create a set of second outputs;
for each output of the set of first outputs and a corresponding output of the set of second outputs, generating a respective matrix based on an optimization technique that maps the corresponding output of the updated root MLM to the output of the original root MLM;
summing the respective generated matrices to create an initial conversion matrix; and
normalizing each column of the initial conversion matrix to generate the conversion matrix.

3. The system of claim 2, wherein the generation of the conversion matrix further comprises weighting each of the generated matrices prior to summing the generated matrices.

4. The system of claim 2, wherein the optimization technique of the generation of the conversion matrix is a greedy algorithm.

5. The system of claim 4, wherein greedy algorithm comprises:
mapping a largest remaining value in an output V2 (V2_val) of the updated root MLM to a largest remaining value in a corresponding output V1 (V1_val) of the original root MLM;
subtracting the lesser of V1_val and V2_val from each of V1_val and V2_val in the outputs, respectively;
determining a new largest remaining value in the output V2 of the updated root MLM; and
repeating the mapping and subtraction steps until the new largest remaining value in the output V2 equals zero; and
converting the mapping into a matrix M such that M*V1=V2.

6. A computer-implemented method comprising providing executable instructions to a hardware processor of a server from a non-transitory computer-readable storage medium causing the hardware processor to perform processing, comprising:
receiving, from a transaction terminal, transaction information for a transaction including an item image for an item of the transaction;
providing the item image to an updated root machine learning model (MLM);
receiving item classification data for a coarse grained item classification determined by the updated root MLM from the item image;
providing the item classification data to a mapping function to produce a mapped version of the item classification data;
providing the mapped version of the item classification data to a head MLM;
receiving a predicted item identifier from the head MLM based on localized metadata processed by the head MLM using the item classification data;
providing the predicted item identifier to the transaction terminal; and
receiving an actual item identifier for the item from the transaction terminal.

7. The computer implemented method of claim 6, wherein the mapping function is a conversion matrix for converting a second output vector V2 representing the item classification data from the updated root MLM to a form of a first output vector V1 representing item classification data from an original root MLM, the conversion matrix generated by:
iteratively feeding a set of example data to the original root MLM to create a set of first outputs and to the updated root MLM to create a set of second outputs;
for each output of the set of first outputs and a corresponding output of the set of second outputs, generating a respective matrix based on an optimization technique that maps the corresponding output of the updated root MLM to the output of the original root MLM;
summing the respective generated matrices to create an initial conversion matrix; and
normalizing each column of the initial conversion matrix to generate the conversion matrix.

8. The computer implemented method of claim 7, wherein the generation of the conversion matrix further comprises weighting each of the generated matrices prior to summing the generated matrices.

9. The computer implemented method of claim 7, wherein the optimization technique of the generation of the conversion matrix is a greedy algorithm.

10. The computer implemented method of claim 9, wherein greedy algorithm comprises:
mapping a largest remaining value in an output V2 (V2_val) of the updated root MLM to a largest remaining value in a corresponding output V1 (V1_val) of the original root MLM;
subtracting the lesser of V1_val and V2_val from each of V1_val and V2_val in the outputs, respectively;
determining a new largest remaining value in the output V2 of the updated root MLM; and
repeating the mapping and subtraction steps until the new largest remaining value in the output V2 equals zero; and
converting the mapping into a matrix M such that M*V1=V2.

11. A computer-implemented method for generating a conversion matrix for mapping an output of a second machine learning model to an expected output of a first machine learning model, comprising:
iteratively feeding a set of example data to the first machine learning model to create a set of first outputs and to the second machine learning model to create a set of second outputs;
for each output of the set of first outputs and a corresponding output of the set of second outputs, generate a respective matrix based on an optimization technique that maps the corresponding output of the second machine learning model to the output of the first machine learning model;
sum the respective generated matrices to create an initial conversion matrix; and
normalize each column of the initial conversion matrix to generate the conversion matrix.

12. The computer-implemented method of claim 11, comprising weighting each of the generated matrices prior to summing the generated matrices.

13. The computer-implemented method of claim 11, wherein the optimization technique is a greedy algorithm.

14. The computer-implemented method of claim 13, wherein greedy algorithm comprises:
mapping a largest remaining value in an output V2 (V2_val) of the second machine learning model to a largest remaining value in a corresponding output V1 (V1_val) of the first machine learning model;
subtracting the lesser of V1_val and V2_val from each of V1_val and V2_val in the outputs, respectively;
determining a new largest remaining value in the output V2 of the second machine learning model; and
repeating the mapping and subtraction steps until the new largest remaining value in the output V2 equals zero; and
converting the mapping into a matrix M such that M*V1=V2.

15. A system for processing input information, comprising:
an updated root-level machine learning model for receiving and processing input information and having a second output vector V2;
a conversion matrix for converting the second output vector V2 to a form of a first output vector V1 of an initial root-level machine learning model for receiving and processing input information; and
a head machine learning model for processing the first output vector V1 to provide a predictive output;
wherein the conversion matrix generated by:
iteratively feeding a set of example data to the initial root-level machine learning model to create a set of first outputs and to the updated root-level machine learning model to create a set of second outputs;
for each output of the set of first outputs and a corresponding output of the set of second outputs, generating a respective matrix based on an optimization technique that maps the corresponding output of the second root-level machine learning model to the output of the first root-level machine learning model;
summing the respective generated matrices to create an initial conversion matrix; and
normalizing each column of the initial conversion matrix to generate the conversion matrix.

16. The system of claim 15, wherein the generation of the conversion matrix further comprises weighting each of the generated matrices prior to summing the generated matrices.

17. The system of claim 15, wherein the optimization technique of the generation of the conversion matrix is a greedy algorithm.

18. The system of claim 17, wherein greedy algorithm comprises:
mapping a largest remaining value in an output V2 (V2_val) of the updated root-level machine learning model to a largest remaining value in a corresponding output V1 (V1_val) of the initial root-level machine learning model;
subtracting the lesser of V1_val and V2_val from each of V1_val and V2_val in the outputs, respectively;
determining a new largest remaining value in the output V2 of the updated root-level machine learning model; and
repeating the mapping and subtraction steps until the new largest remaining value in the output V2 equals zero; and
converting the mapping into a matrix M such that M*V1=V2.
